(19) United States
(12) Patent Application Publication
(10) Pub. No.: US 2023/0032143 A1
(43) Pub. Date: Feb. 2, 2023

(54) LOG GENERATION APPARATUS, LOG GENERATION METHOD, AND COMPUTER READABLE RECORDING MEDIUM

(71) Applicant: NEC Corporation, Minato-ku, Tokyo (JP)

(72) Inventors: Daichi HASUMI, Tokyo (JP); Shigeyoshi SHIMA, Tokyo (JP)

(73) Assignee: NEC Corporation, Minato-ku, Tokyo (JP)

(21) Appl. No.: 17/798,384

(22) PCT Filed: Feb. 25, 2020
(86) PCT No.: PCT/JP2020/007534

§ 371 Date: Aug. 9, 2022

(51) Int. Cl. G06F 21/55

(52) U.S. Cl. CPC G06F 21/554; G06F 2221/034

(57) ABSTRACT

A log generation apparatus includes: a log classifying unit that classifies log data formed of a plurality of logs into groups based on log types; a statistical model generating unit that performs, for each of the groups, a conversion of the logs classified into the group into events that are each formed of two or more logs, and further generates a statistical model by calculating, for each of the events obtained by the conversion, an appearance probability of the event based on the times of occurrence of the event and the number of instances of the event; and a log information generating unit that selects a specific event in accordance with the appearance probabilities of the events in the statistical model and generates new logs, or log information for generating the new logs, using text data that corresponds to the selected event and that has been prepared beforehand.

### TECHNICAL FIELD

The invention relates to a log generation apparatus and a log generation method for generating logs necessary in cybersecurity training, and further relates to a computer readable recording medium for realizing the log generation apparatus and the log generation method.

### BACKGROUND ART

Recent years have seen an increase in damages such as the leakage of information and suspension of businesses due to cyberattacks targeting organizations, and thus there is a demand to strengthen cyberattack countermeasures. Furthermore, in order to strengthen cyberattack countermeasures, it is indispensable to improve the investigation skills of system security administrators. Thus, cybersecurity training (or cybertraining) is provided in which trainees are encouraged to find logs that are traces of incidents (such logs are referred to in the following as “attack logs”). In cybersecurity training, attack logs to be provided to trainees are prepared beforehand by human work.

However, it is time-consuming to prepare attack logs by human work. Furthermore, while Patent Document 1 discloses a technique for generating logs in a computer system, the generation of attack logs differs from the generation of regular logs in that information regarding the attack tool characteristics and execution method is necessary. Thus, Non-Patent Document 1 proposes a method for acquiring attack logs easily and efficiently.

### List of Related Art Documents

### Patent Document

Patent Document 1: International Publication No. 2018/186314

### Non-Patent Document

Non-Patent Document 1: Yusuke Takahashi and four others, “An Approach to Attack Scenario Generation for Simulation of Targeted Attacks”, IEICE, IEICE technical report, vol. 119, no. 140, ISEC2019-13, pages 7-14, July 2019

### SUMMARY OF INVENTION

### Problems to Be Solved by the Invention

Incidentally, cybersecurity training involves searching for attack logs indicating traces of incidents from among regular work logs that are not related to incidents (such logs are referred to in the following as “normal logs”). Thus, not only attack logs but also normal logs are necessary beforehand for cybersecurity training.

However, normal logs cannot be generated using the method disclosed in Non-Patent Document 1. Due to this, in cybersecurity training, normal logs are acquired by recording logs of regular operations performed on a terminal under an assumed environment over a long period of time, or through preparation by human work.

However, a large number of normal logs are necessary for cybersecurity training. This is because, while trainees need to take multiple cybersecurity training sessions to improve their investigation skills, an improvement in investigation skills cannot be expected if the same normal logs are used multiple times, and thus normal logs need to be prepared newly for each training session. Thus, it is very difficult to acquire the necessary number of normal logs using the above-described method.

An example object of the invention is to provide a log generation apparatus, a log generation method, and a computer readable recording medium that resolve the above-described problems and can generate normal logs necessary in cybersecurity training without the output of logs from a terminal operating under a set environment and without human work.

### SUMMARY OF INVENTION

### Problems to Be Solved by the Invention

In order to achieve the above-described object, a log generation apparatus includes:
a log classifying unit that classifies log data formed of a plurality of logs into groups based on log types;
a statistical model generating unit that performs, for each of the groups, a conversion of the logs classified into the group into events that are each formed of two or more logs, and further generates a statistical model by calculating, for each of the events obtained by the conversion, an appearance probability of the event based on the times of occurrence of the event and the number of instances of the event; and
a log information generating unit that selects a specific event in accordance with the appearance probabilities of the events in the statistical model and generates new logs, or log information for generating the new logs, using text data that corresponds to the selected event and that has been prepared beforehand.

In addition, in order to achieve the above-described object, a log generation method includes:
a log classifying step of classifying log data formed of a plurality of logs into groups based on log types;
a statistical model generating step of performing, for each of the groups, a conversion of the logs classified into the group into events that are each formed of two or more logs, and further generating a statistical model by calculating, for each of the events obtained by the conversion, an appearance probability of the event based on the times of occurrence of the event and the number of instances of the event; and
a log information generating step of selecting a specific event in accordance with the appearance probabilities of the events in the statistical model and generating new logs, or log information for generating the new logs, using text data that corresponds to the selected event and that has been prepared beforehand.

Furthermore, in order to achieve the above-described object, a computer readable recording medium according to an example aspect of the invention is a computer readable recording medium that includes recorded thereon a program,
the program including instructions that cause the computer to carry out:
a log classifying step of classifying log data formed of a plurality of logs into groups based on log types;
a statistical model generating step of performing, for each of the groups, a conversion of the logs classified into the group into events that are each formed of two or more logs, and further generating a statistical model by calculating, for each of the events obtained by the conversion, an appearance probability of the event based on the times of occurrence of the event and the number of instances of the event; and
a log information generating step of selecting a specific event in accordance with the appearance probabilities of the events in the statistical model and generating new logs, or log information for generating the new logs, using text data that corresponds to the selected event and that has been prepared beforehand.

### Advantageous Effects of the Invention

As described above, according to the invention, it is possible to generate normal logs necessary in cybersecurity training without the output of logs from a terminal operating under a set environment and without human work.

### BRIEF DESCRIPTION OF THE DRAWINGS

FIG. 1 is a block diagram illustrating the overall configuration of the log generation apparatus in first example embodiment.

FIG. 2 is a block diagram illustrating the configuration of the log generation apparatus in first example embodiment in detail.

FIG. 3 is a diagram illustrating one example of the log classification rules used in first example embodiment.

FIG. 4 is a diagram illustrating one example of the templates used in first example embodiment.

FIG. 5 is a diagram schematically illustrating one example of the statistical models generated in first example embodiment.

FIG. 6 is a diagram illustrating one example of the logs generated in first example embodiment.

FIG. 7 is a flowchart illustrating operations of the log generation apparatus in first example embodiment.

FIG. 8 is a block diagram illustrating the configuration of the log generation apparatus in second example embodiment in detail.

FIG. 9 is a diagram illustrating one example of the actual operation templates used in second example embodiment.

FIG. 10 is a flowchart illustrating operations of the log generation apparatus in second example embodiment.

FIG. 11 is a block diagram illustrating an example of a computer that realizes the log generation apparatus according to the first and second example embodiment.

### EXAMPLE EMBODIMENT

### First Example Embodiment

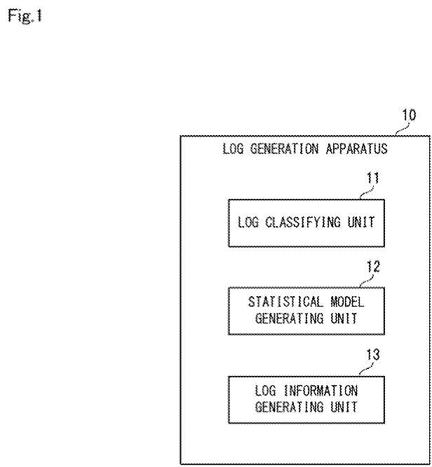

In the following, a log generation apparatus, a log generation method, and a program in first example embodiment will be described with reference to FIGS. 1 to 7.

### Apparatus Configuration

First, the overall configuration of the log generation apparatus in first example embodiment will be described with reference to FIG. 1. FIG. 1 is a block diagram illustrating the overall configuration of the log generation apparatus in first example embodiment.

The log generation apparatus 10 in first example embodiment illustrated in FIG. 1 is an apparatus that generates logs that are necessary in cybersecurity training. As illustrated in FIG. 1, the log generation apparatus 10 includes a log classifying unit 11, a statistical model generating unit 12, and a log information generating unit 13.

In such a configuration, the log classifying unit 11 classifies log data formed of a plurality of logs into groups based on log types.

The statistical model generating unit 12 performs, for each of the groups, a conversion of the logs classified into the group into events that are each formed of two or more logs. Furthermore, the statistical model generating unit 12 generates a statistical model by calculating, for each of the events obtained by the conversion, an appearance probability of the event based on the times of occurrence of the event and the number of instances of the event.

The log information generating unit 13 selects a specific event in accordance with the appearance probabilities of the events in the statistical model and generates new logs, or log information for generating the new logs, using text data that corresponds to the selected event and that has been prepared beforehand.

In such a manner, in first example embodiment, a statistical model is generated from a plurality of logs classified into a group, and new logs, or log information for generating new logs, are/is generated using the generated statistical model. According to first example embodiment, normal logs necessary in cybersecurity training can be generated without the output of logs from a terminal operating under a set environment and without human work.

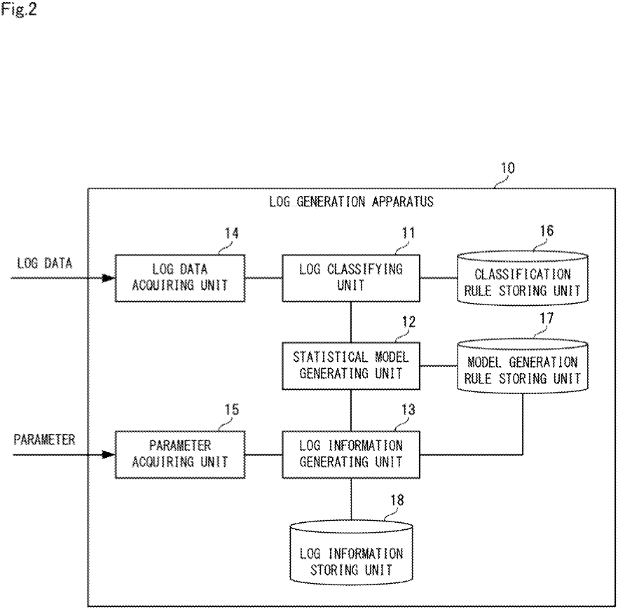

Next, the configuration of the log generation apparatus 10 in first example embodiment will be described in detail with reference to FIGS. 2 to 6 in addition to FIG. 1. FIG. 2 is a block diagram illustrating the configuration of the log generation apparatus in first example embodiment in detail.

As illustrated in FIG. 2, in first example embodiment, the log generation apparatus 10 includes a log data acquiring unit 14, a parameter acquiring unit 15, a classification rule storing unit 16, a model generation rule storing unit 17, and a log information storing unit 18, in addition to the above-described log classifying unit 11, statistical model generating unit 12, and log information generating unit 13.

In the example embodiments, the log data acquiring unit 14 acquires log data from a computer that is connected to the log generation apparatus 10 via a network. Specifically, a log collection tool is installed to the computer from which log data is to be acquired, and this log collection tool collects logs generated by the computer and outputs the set of collected logs to the log generation apparatus 10 as log data. The log data acquiring unit 14 acquires the log data output by the log collection tool.

For example, CDIR-Collector can be mentioned as an example of the log collection tool. Furthermore, in a case in which CDIR-Collector is used, logs are converted into JSON files by plaso in the computer from which logs are collected because CDIR-Collector also collects binary format logs specific to Windows (registered trademark). In this case, the log data acquiring unit acquires log data formed of logs converted into JSON files.

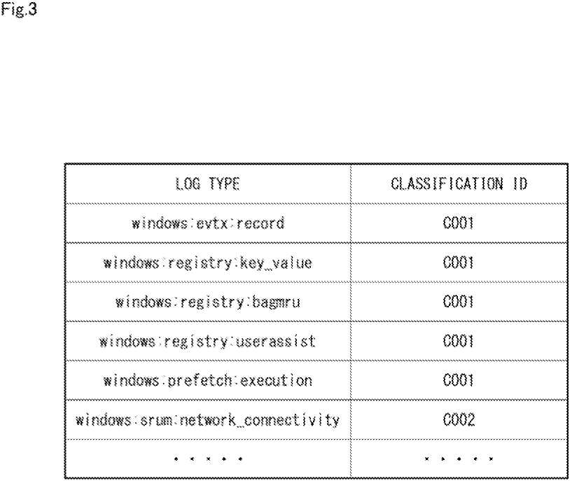

In first example embodiment, the log classifying unit 11 classifies log data formed of a plurality of logs into groups in accordance with log classification rules. The log classification rules are rules for classifying logs in accordance with log types. FIG. 3 is a diagram illustrating one example of the log classification rules used in first example embodiment. Furthermore, the log classification rules are prepared beforehand based on domain knowledge, and are stored in the classification rule storing unit 16.

Specifically, the log classification rules define a corresponding classification ID for each log type, as illustrated in FIG. 3. Accordingly, for each log included in the log data acquired by the log data acquiring unit 14, the log classifying unit 11 specifies a corresponding classification ID by referring to the log classification rules. The classification IDs are IDs for specifying groups, and each log is classified into a group by a classification ID being specified.

In first example embodiment, the statistical model generating unit 12 uses templates to perform, for each of the groups, a conversion of the logs classified into the group into events that are each formed of two or more logs. Furthermore, the statistical model generating unit 12 generates a statistical model by converting the events into appearance probabilities in individual time periods. The templates are data in which, for each of the events, log text included in corresponding logs is registered.

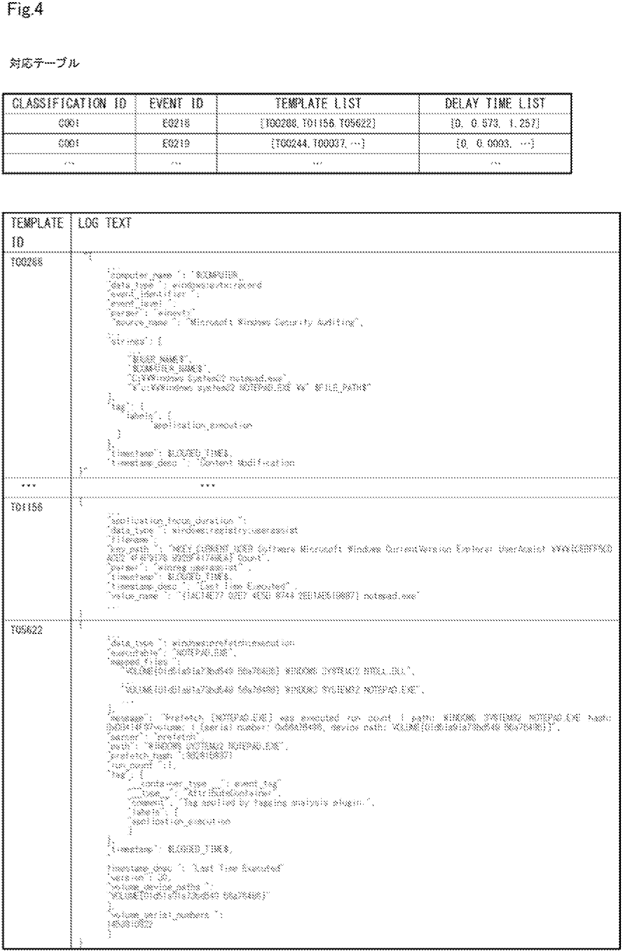

FIG. 4 is a diagram illustrating one example of the templates used in first example embodiment. In the example in FIG. 4, the templates are stored in the model generation rule storing unit 17 as model generation rules, together with a correspondence table. Furthermore, the correspondence table associates each template with an event (event ID), a classification ID, and a delay time list that correspond to the template. Also, in the correspondence table, a plurality of templates corresponding to the same event ID are grouped together as a template list. Furthermore, a delay time list indicates differences between execution times of templates, with the template first in a template list being the reference.

Specifically, the statistical model generating unit 12 selects one of the groups into which logs have been classified, and sets each of the logs classified into the selected group as a target log. Next, the statistical model generating unit 12 specifies, from the model generation rule storing unit 17, event IDs corresponding to the classification ID of the selected group.

Furthermore, the statistical model generating unit 12 acquires the template IDs first in the template lists corresponding to the specified events IDs, reads pieces of log text corresponding to the acquired first template IDs, and sets the read pieces of log text as event trigger candidates.

Subsequently, the statistical model generating unit 12 deletes characteristic values included in the target logs. The characteristic values that are deleted are the values corresponding to the variables between “$” in the pieces of log text illustrated in FIG. 4.

Next, for each of the event trigger candidates, the statistical model generating unit 12 calculates the distance from each of the target logs, and if there is an event trigger candidate for which the distance is equal to or less than a threshold, the statistical model generating unit 12 determines that the event trigger candidate is an event trigger. For example, the Levenshtein distance can be mentioned as an example of the distance calculated here. Furthermore, a small value such as “8” is used as the threshold because characteristic values have been eliminated from the target logs.

Next, the statistical model generating unit 12 specifies the second and subsequent template IDs from the template list corresponding to the event ID of the event trigger. Subsequently, the statistical model generating unit 12 determines whether or not pieces of log text corresponding to the second and subsequent template IDs that have been specified appear in order in the target logs subsequent to the target log for which the distance from the event trigger was equal to or less than the threshold (such target logs are referred to in the following simply as “subsequent target logs”). That is, for the subsequent target logs, the statistical model generating unit 12 sequentially calculates the distance from the pieces of log text corresponding to the second and subsequent template IDs.

Furthermore, suppose that, as a result of the determination, the target log-log text distance was equal to or less than the threshold for all of the template IDs included in the template list corresponding to the event trigger, or in other words, all events corresponding to the event trigger have occurred. In this case, the statistical model generating unit 12 adds, to the event ID corresponding to the event trigger, a time stamp (also referred to as “event time”) of the target log for which the distance was first calculated as being equal to or less than the threshold, and holds the event ID having the time stamp added thereto. Note that the event time here is the time of occurrence of the event.

Furthermore, if there is a group that is yet to be selected, the statistical model generating unit 12 also performs similar processing for the group and holds event IDs corresponding to event triggers. In the following, a set of event IDs held in such a manner is referred to as an “event sequence”.

Furthermore, the statistical model generating unit 12 divides the twenty-four hours of a day by an any time width to set time windows, and holds event IDs for each time window based on event times. Subsequently, the statistical model generating unit 12, for logs corresponding to a single day for example, totals the number of instances of an event ID held in the time windows.

Furthermore, for each time window, the statistical model generating unit 12 divides the number of instances of the event ID held in the time window by the total value. Quotients obtained by performing this division are the appearance probabilities of events. Furthermore, in a case such as that described above in which the period of received logs is set to a single day, the statistical model generating unit 12 can also specify the daily average number of events in each time window.

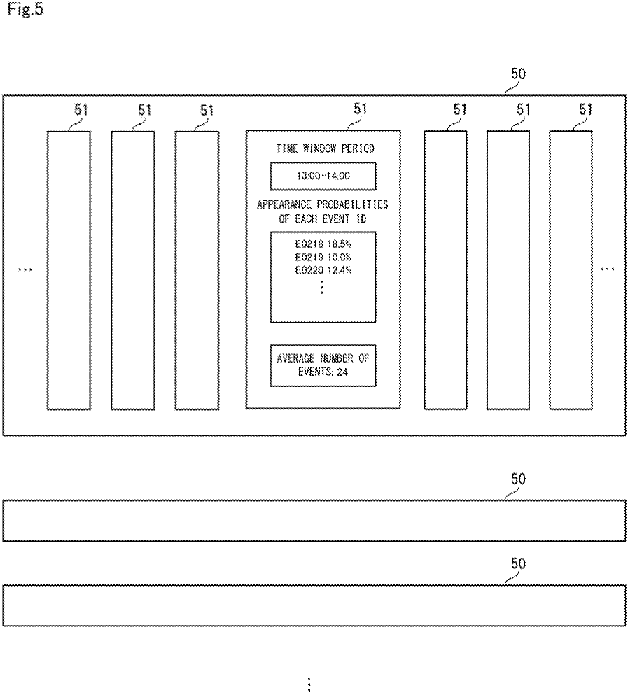

For example, the statistical model generating unit 12 generates the statistical models illustrated in FIG. 5 using the appearance probabilities of events. FIG. 5 is a diagram schematically illustrating one example of the statistical models generated in first example embodiment. In the example in FIG. 5, a statistical model 50 holds, in units of single days, the appearance probabilities of events and the average number of events in each time window 51. Furthermore, in FIG. 5, the statistical models 50 respectively correspond to different classification IDs.

The parameter acquiring unit 15 acquires parameters to be used in the processing by the log information generating unit 13. As examples of the parameters, a computer name, a usemame, an IP address, a log generation start time, and a log generation end time can be mentioned. Furthermore, the parameters are generated by an administrator of the log generation apparatus 10, and are then input via an administrator terminal or the like, for example.

In first example embodiment, the log information generating unit 13 selects a specific event in accordance with the appearance probabilities of events in a statistical model, and then performs matching between the selected event and the templates. Furthermore, the log information generating unit 13 acquires log text corresponding to the selected event based on the result of the matching, and generates new logs using the acquired log text as text data.

Specifically, the log information generating unit 13 first receives the acquired parameters from the parameter acquiring unit 15. Next, the log information generating unit 13 sets the generation start time included in the acquired parameters as a log generation target time, and specifies a time window to which the target time corresponds in a statistical model generated by the statistical model generating unit 12.

Subsequently, in accordance with the appearance probabilities in the statistical model, the log information generating unit 13 selects one event ID from the group of event IDs included in the specified time window. Furthermore, the log information generating unit 13 repeats the selection of an event ID until the daily average number of events in the specified time window is reached.

Next, the log information generating unit 13 executes the processing in (a) to (d) below for each of the selected event IDs.
(a) Based on the template lists corresponding to the selected group of event IDs, a group of log text associated with the templates is acquired.
(b) The replacement-target character sequences (the portions between “$” in the pieces of log text illustrated in FIG. 4) in the group of log text are replaced with parameters received from the parameter acquiring unit 15.
(c) A time is randomly set within the specified time window, and the set time is adopted as a log appearance time. However, for each log in the second and subsequent templates in the template list, the numerical value at the same position in the delay time list of the corresponding event ID is added to the initially set appearance time, and the appearance time obtained in such a manner is set as log appearance time of the log.
(d) The log appearance times and log text (similar logs) in which the replacement with parameters has been performed are stored to the log information storing unit 18.

Subsequently, after executing the above-described processing in (a) to (d) for each event ID, the log information generating unit 13 updates the log generation target time with a time calculated by “current log generation target time + time-window time width”. Then, the log information generating unit 13 repeats the above-described selection of a group of event IDs and the above-described processing in (a) to (d) for each event ID until the log generation target time reaches the log generation end time included in the parameters.

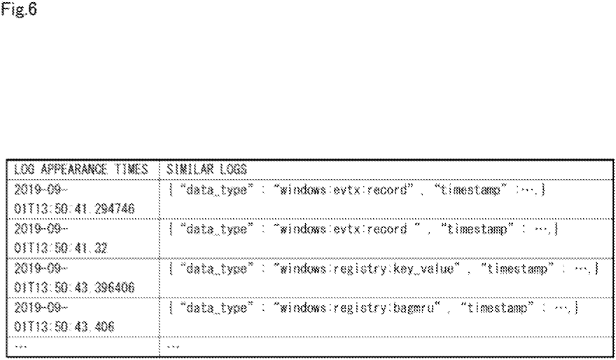

Then, as illustrated in FIG. 6, the log information generating unit 13 stores the generated similar logs to the log information generating unit 13. FIG. 6 is a diagram illustrating one example of the logs generated in first example embodiment. As illustrated in FIG. 6, the log information generating unit 13 stores the newly generated similar logs (log text in which replacement has been performed) and the log appearance times so as to be associated with one another. Then, the similar logs and the log appearance times stored in the log information generating unit 13 are sent to terminal devices and the like used in cybersecurity training.

### Apparatus Operations

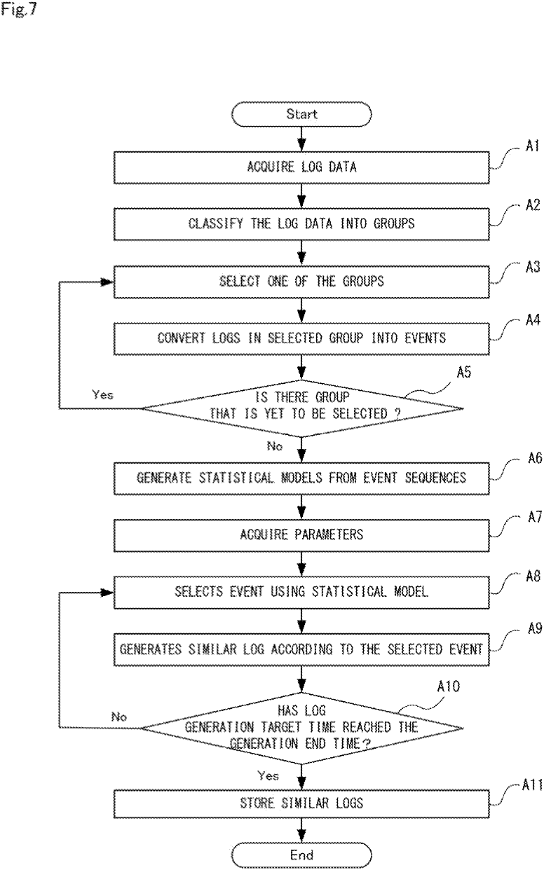

Next, operations of the log generation apparatus 10 in first example embodiment will be described with reference to FIG. 7. FIG. 7 is a flowchart illustrating operations of the log generation apparatus in first example embodiment. FIGS. 1 to 6 will be referred to as needed in the following description. Also, in first example embodiment, a log generation method is implemented by causing the log generation apparatus 10 to operate. Accordingly, the following description of the operations of the log generation apparatus 10 is substituted for the description of the log generation method in first example embodiment.

As illustrated in FIG. 7, first, the log data acquiring unit 14 acquires log data from a computer connected to the log generation apparatus 10 via a network (step A1).

Next, the log classifying unit 11 classifies the log data, which is formed of a plurality of logs, into groups in accordance with the log classification rules illustrated in FIG. 3, for example (step A2).

Next, the statistical model generating unit 12 selects one of the groups into which the logs have been classified in step A2 (step A3). Next, the statistical model generating unit 12 converts the logs in the selected group into events that are each formed of two or more logs using the templates illustrated in FIG. 4, for example (step A4).

Specifically, in step A4, the logs classified into the selected group are set as target logs, and event IDs corresponding to the classification ID of the selected group are specified. Furthermore, for each of the specified event IDs, the statistical model generating unit 12 reads log text corresponding to the first template ID in the corresponding template list, and sets the read log text as an event trigger candidate.

Subsequently, in step A4, the statistical model generating unit 12 deletes characteristic values in the target logs, and, for each event trigger candidate, calculates the distance from each of the target logs, and sets an event trigger candidate for which the distance is equal to or less than the threshold as an event trigger. Next, the statistical model generating unit 12 specifies the second and subsequent template IDs from the template list corresponding to the event ID of the event trigger, and sequentially calculates the distance from the pieces of log text corresponding to the second and subsequent template IDs also for the subsequent target logs.

Furthermore, suppose that the target log-log text distance was equal to or less than the threshold for all of the template IDs included in the template list corresponding to the event trigger. In this case, in step A4, the statistical model generating unit 12 adds, to the event ID corresponding to the event trigger, a time stamp (event time) of the target log for which the distance was first calculated as being equal to or less than the threshold, and holds the event ID having the time stamp added thereto.

Next, after executing step A4, the statistical model generating unit 12 determines whether or not there is a group that is yet to be selected (step A5). If the result of the determination in step A5 is that there is a group that is yet to be selected, the statistical model generating unit 12 executes steps A3 and A4 again.

On the other hand, if the result of the determination in step A5 is that there is no group that is yet to be selected, the statistical model generating unit 12 generates statistical models from the event sequences obtained in step A4 (step A6).

Specifically, in step A6, the statistical model generating unit 12 divides the twenty-four hours of a day by any time width to set time windows, and holds event IDs for each time window based on event times. Subsequently, the statistical model generating unit 12, for logs corresponding to a single day for example, totals the number of instances of an event ID held in the time windows, and, for each time window, divides the number of instances of the event ID held in the time window by the total value. For example, the statistical model generating unit 12 generates the statistical models illustrated in FIG. 5 using quotients obtained by performing this division as the appearance probabilities of events.

Next, the parameter acquiring unit 15 acquires parameters to be used in the processing by the log information generating unit 13 in step A9 (step A7).

Next, the log information generating unit 13 selects a specific event in accordance with the appearance probabilities of events in a statistical model (step A8).

Specifically, in step A8, the log information generating unit 13 sets the generation start time included in the parameters acquired in step A7 as a log generation target time, and specifies a time window to which the target time corresponds in the statistical model. Subsequently, in accordance with the appearance probabilities in the statistical model, the log information generating unit 13 selects one event ID from the group of event IDs included in the specified time window. Note that the selection of an event ID is repeated until the daily average number of events is reached.

Next, the log information generating unit 13 performs matching between the selected event and templates, acquires log text corresponding to the selected event based on the result of the matching, and generates similar logs using the acquired log text as text data (step A9).

Specifically, in step A9, the log information generating unit 13 executes the above-described processing in (a) to (d) for each of the selected event IDs. Furthermore, after executing the above-described processing in (a) to (d) for each event ID, the log information generating unit 13 updates the log generation target time with a time calculated by “current log generation target time + time-window time width”.

Then, the log information generating unit 13 determines whether or not the log generation target time has reached the log generation end time included in the parameters (step A10). If the result of the determination in step A10 is that the log generation target time has not reached the log generation end time, the log information generating unit 13 executes steps A8 and A9 again at the updated target time.

On the other hand, if the result of the determination in step A10 is that the log generation target time has reached the log generation end time, the log information generating unit 13 stores the similar logs generated in step A9 to the log information generating unit 13 (step A11).

According to present first example embodiment, from a plurality of logs classified into a group, events corresponding to the logs are specified, and a statistical model is generated based on the appearance probabilities of the events in such a manner. Furthermore, similar logs can be obtained using the statistical model. Hence, according to first example embodiment, normal logs necessary in cybersecurity training can be generated without the output of logs from a terminal operating under a set environment and without human work.

### Program

It suffices for a program in the first example embodiment of the invention to be a program that causes a computer to carry out steps A1 to A11 illustrated in FIG. 7. Also, by this program being installed and executed in the computer, the log generation apparatus 10 and the log generation method according to the first example embodiment can be realized. In this case, a processor of the computer functions and performs processing as the log classifying unit 11, the statistical model generating unit 12, the log information generating unit 13, the log data acquiring unit 14 and the parameter acquiring unit 15.

Also, the classification rule storing unit 16, the model generation rule storing unit 17, and the log information storing unit 18 are realized by storing a data file constituting them into a storage device, such as a hard disk, included in the computer. Also, the classification rule storing unit 16, the model generation rule storing unit 17, and the log information storing unit 18 may be realized by a computer that is different from the computer that executes the program according to the first example embodiment.

Furthermore, the program according to the present example embodiment may be executed by a computer system constructed with a plurality of computers. In this case, for example, each computer may function as one of the log classifying unit 11, the statistical model generating unit 12, the log information generating unit 13, the log data acquiring unit 14 and the parameter acquiring unit 15.

### Second Example Embodiment

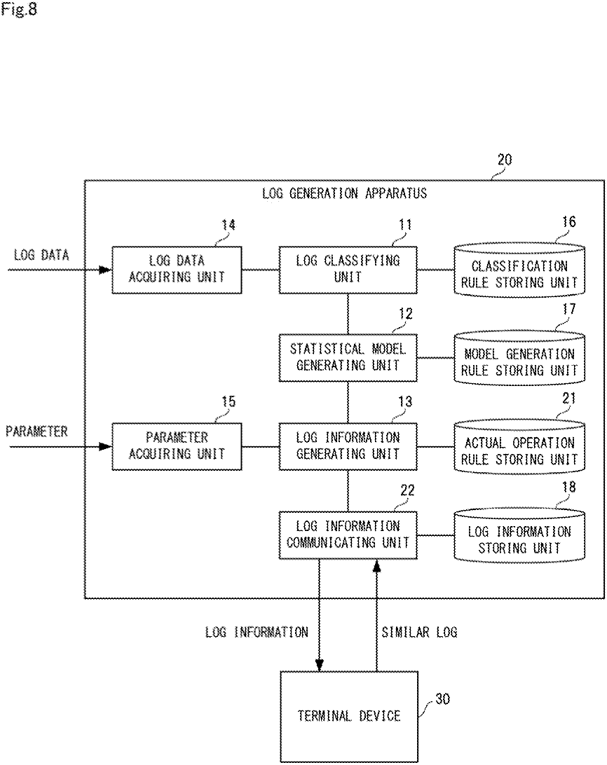

Next, a log generation apparatus, a log generation method, and a program in second example embodiment will be described with reference to FIGS. 8 to 10.

### Apparatus Configuration

First, the overall configuration of the log generation apparatus in second example embodiment will be described with reference to FIG. 8. FIG. 8 is a block diagram illustrating the configuration of the log generation apparatus in second example embodiment in detail.

Similarly to the log generation apparatus 10 in first example embodiment, the log generation apparatus 20 in second example embodiment illustrated in FIG. 8 is also an apparatus that generates logs that are necessary in cybersecurity training.

The log generation apparatus 20 differs from the log generation apparatus 10 in first example embodiment in that, as illustrated in FIG. 8, the log generation apparatus 20 includes an actual operation rule storing unit 21 and a log information communicating unit 22 in addition to the configuration illustrated in FIG. 2, and also differs from the log generation apparatus 10 in terms of the function of the log information generating unit 13. In the following, description will be provided focusing on the differences from first example embodiment.

In second example embodiment, the log information generating unit 13 uses actual operation templates to specify a command sequence corresponding to a selected event, and generates log information using the specified command sequence as text data.

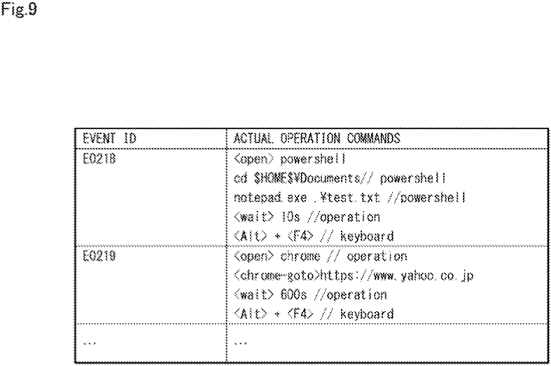

In the actual operation templates, a command sequence for generating corresponding logs is registered for each event (event ID), as illustrated in FIG. 9. FIG. 9 is a diagram illustrating one example of the actual operation templates used in second example embodiment. Note that the commands that are specified are referred to as “actual operation commands”.

Specifically, the log information generating unit 13 first receives the acquired parameters from the parameter acquiring unit 15. Next, the log information generating unit 13 sets the generation start time included in the acquired parameters as a log generation target time, and specifies a time window to which the target time corresponds in a statistical model generated by the statistical model generating unit 12.

Next, in accordance with the appearance probabilities in the statistical model, the log information generating unit 13 selects one event ID from the group of event IDs included in the specified time window. Furthermore, the log information generating unit 13 repeats the selection of an event ID until the daily average number of events in the specified time window is reached.

Next, for each of the selected event IDs, the log information generating unit 13 acquires actual operation commands associated with the event ID based on the actual operation templates. The actual operation commands that are acquired serve as log information for generating new logs.

In such a manner, the log information generating unit 13 uses a statistical model generated by the statistical model generating unit 12 and obtains an actual operation command sequence serving as log information based on the actual operation templates stored in the actual operation rule storing unit 21.

Then, the log information generating unit 13 passes, to the log information communicating unit 22, the actual operation commands corresponding to the selected event IDs. Accordingly, the log information communicating unit 22 transmits the actual operation commands to a terminal device 30.

Upon receiving the actual operation commands transmitted thereto, the terminal device 30 executes the received actual operation commands. Furthermore, after executing the actual operation commands, the terminal device 30 collects logs that were generated when the actual operation commands were executed, and transmits the collected logs to the log generation apparatus 10.

In the log generation apparatus 20, the log information communicating unit 22 stores the transmitted logs to the log information storing unit 18 as new logs (similar logs).

### Apparatus Operations

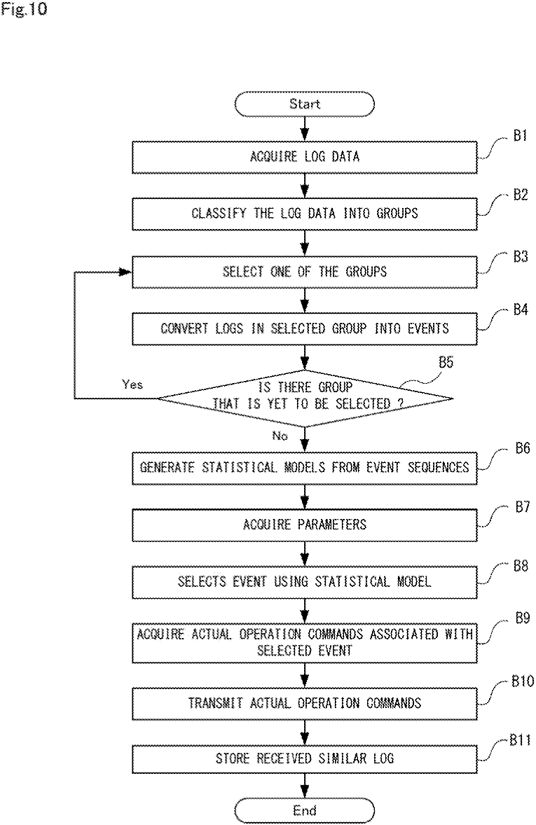

Next, operations of the log generation apparatus 20 in second example embodiment will be described with reference to FIG. 10. FIG. 10 is a flowchart illustrating operations of the log generation apparatus in second example embodiment. FIGS. 8 and 9 will be referred to as needed in the following description. Also, in second example embodiment, a log generation method is implemented by causing the log generation apparatus 20 to operate. Accordingly, the following description of the operations of the log generation apparatus 20 is substituted for the description of the log generation method in second example embodiment.

As illustrated in FIG. 10, first, the log data acquiring unit 14 acquires log data from a computer connected to the log generation apparatus 20 via a network (step B1).

Next, the log classifying unit 11 classifies the log data, which is formed of a plurality of logs, into groups in accordance with the log classification rules illustrated in FIG. 3, for example (step B2).

Next, the statistical model generating unit 12 selects one of the groups into which the logs have been classified in step B2 (step B3). Next, the statistical model generating unit 12 converts the logs in the selected group into events that are each formed of two or more logs using the templates illustrated in FIG. 4, for example (step B4).

Next, after executing step B4, the statistical model generating unit 12 determines whether or not there is a group that is yet to be selected (step B5). If the result of the determination in step B5 is that there is a group that is yet to be selected, the statistical model generating unit 12 executes steps B3 and B4 again.

On the other hand, if the result of the determination in step B5 is that there is no group that is yet to be selected, the statistical model generating unit 12 generates statistical models from the event sequences obtained in step B4 (step B6).

Next, the parameter acquiring unit 15 acquires parameters to be used in the processing by the log information generating unit 13 in step B9 (step B7).

Next, the log information generating unit 13 selects a specific event in accordance with the appearance probabilities of events in a statistical model (step B8). Note that the above-described steps B1 to B8 are respectively similar to steps A1 to A8 illustrated in FIG. 7.

Next, for each of the selected event IDs, the log information generating unit 13 acquires actual operation commands associated with the event ID based on the actual operation templates illustrated in FIG. 9 (step B9). The actual operation commands that are acquired serve as log information for generating new logs.

Next, the log information generating unit 13 passes, to the log information communicating unit 22, the actual operation commands corresponding to the selected event IDs. Accordingly, the log information communication unit 22 transmits the actual operation commands to a terminal device 30 (step B10).

Once step B10 is executed, the terminal device 30 receives the transmitted actual operation commands and executes the received actual operation commands. Furthermore, after executing the actual operation commands, the terminal device 30 collects logs that were generated when the actual operation commands were executed, and transmits the collected logs to the log generation apparatus 10.

Next, when logs are transmitted from the terminal device, the log information communicating unit 22 receives the transmitted logs, and stores the received logs to the log information storing unit 18 as new logs (similar logs) (step B11).

According to present second example embodiment, from a plurality of logs classified into a group, events corresponding to the logs are specified, and a statistical model is generated based on the appearance probabilities of the events, similarly to first example embodiment. Furthermore, log information for generating similar logs can be obtained using the statistical model. In second example embodiment as well, normal logs necessary in cybersecurity training can be generated without the output of logs from a terminal operating under a set environment and without human work, similarly to first example embodiment.

In addition, if the terminal device 30 is set as a honeypot in second example embodiment, logs would be output from the honeypot frequently. Thus, an attacker will end up attacking this terminal device 30 without realizing that the terminal device 30 is a honeypot. A honeypot is a terminal device serving as a “bait” that is set as a target for attackers in order to improve security.

### Program

It suffices for a program in the first example embodiment of the invention to be a program that causes a computer to carry out steps B1 to B11 illustrated in FIG. 10. Also, by this program being installed and executed in the computer, the log generation apparatus 20 and the log generation method according to the second example embodiment can be realized. In this case, a processor of the computer functions and performs processing as the log classifying unit 11, the statistical model generating unit 12, the log information generating unit 13, the log data acquiring unit 14, the parameter acquiring unit 15, and the log information communicating unit 22.

Also, the classification rule storing unit 16, the model generation rule storing unit 17, the log information storing unit 18, and the actual operation rule storing unit 21 are realized by storing a data file constituting them into a storage device, such as a hard disk, included in the computer. Also, the classification rule storing unit 16, the model generation rule storing unit 17, the log information storing unit 18, and the actual operation rule storing unit 21 may be realized by a computer that is different from the computer that executes the program according to the second example embodiment.

Furthermore, the program according to the present example embodiment may be executed by a computer system constructed with a plurality of computers. In this case, for example, each computer may function as one of the log classifying unit 11, the statistical model generating unit 12, the log information generating unit 13, the log data acquiring unit 14, the parameter acquiring unit 15, and the log information communicating unit 22.

### Physical Configuration

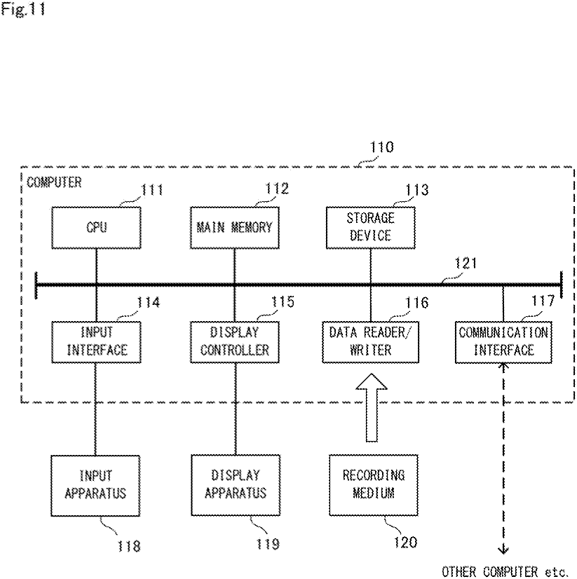

Using FIG. 11, the following describes a computer that realizes the log generation apparatus 10 by executing the program according to the first and second example embodiment. FIG. 11 is a block diagram illustrating an example of a computer that realizes the log generation apparatus according to the first and second example embodiment.

As shown in FIG. 11, a computer 110 includes a CPU (Central Processing Unit) 111, a main memory 112, a storage device 113, an input interface 114, a display controller 115, a data reader/writer 116, and a communication interface 117. These components are connected in such a manner that they can perform data communication with one another via a bus 121.

The computer 110 may include a GPU (Graphics Processing Unit) or an FPGA (Field-Programmable Gate Array) in addition to the CPU 111, or in place of the CPU 111.

The CPU 111 carries out various types of calculation by deploying the program (codes) according to the present example embodiment stored in the storage device 113 to the main memory 112 and executing the codes in a predetermined order. The main memory 112 is typically a volatile storage device, such as a DRAM (dynamic random-access memory). Also, the program according to the example embodiment is provided in a state where it is stored in a computer-readable recording medium 120. Note that the program according to the example embodiment may be distributed over the Internet connected via the communication interface 117.

Also, specific examples of the storage device 113 include a hard disk drive and a semiconductor storage device, such as a flash memory. The input interface 114 mediates data transmission between the CPU 111 and an input apparatus 118, such as a keyboard and a mouse. The display controller 115 is connected to a display apparatus 119, and controls display on the display apparatus 119.

The data reader/writer 116 mediates data transmission between the CPU 111 and the recording medium 120, reads out the program from the recording medium 120, and writes the result of processing in the computer 110 to the recording medium 120. The communication interface 117 mediates data transmission between the CPU 111 and another computer.

Specific examples of the recording medium 120 include: a general-purpose semiconductor storage device, such as CF (CompactFlash^{®}) and SD (Secure Digital); a magnetic recording medium, such as a flexible disk; and an optical recording medium, such as a CD-ROM (Compact Disk Read Only Memory).

Note that the log generation apparatus 10 according to the example embodiment can also be realized by using items of hardware that respectively correspond to the components, rather than the computer in which the program is installed. Furthermore, a part of the log generation apparatus 10 may be realized by the program, and the remaining part of the log generation apparatus 10 may be realized by hardware.

A part or an entirety of the above-described example embodiment can be represented by (Supplementary Note 1) to (Supplementary Note 12) described below but is not limited to the description below.

### Supplementary Note 1

A log generation apparatus including:
a log classifying unit that classifies log data formed of a plurality of logs into groups based on log types;
a statistical model generating unit that performs, for each of the groups, a conversion of the logs classified into the group into events that are each formed of two or more logs, and further generates a statistical model by calculating, for each of the events obtained by the conversion, an appearance probability of the event based on the times of occurrence of the event and the number of instances of the event; and
a log information generating unit that selects a specific event in accordance with the appearance probabilities of the events in the statistical model and generates new logs, or log information for generating the new logs, using text data that corresponds to the selected event and that has been prepared beforehand.

### Supplementary Note 2

The log generation apparatus according to Supplementary Note 1, wherein

for each of the groups, the statistical model generating unit converts the logs classified into the group into events that are each formed of two or more logs using templates in which, for each of the events, log text included in corresponding logs is registered.

### Supplementary Note 3

The log generation apparatus according to Supplementary Note 2, wherein

the log information generating unit performs matching between the selected event and the templates, acquires log text corresponding to the selected event, and generates the new logs using the acquired log text as the text data.

### Supplementary Note 4

The log generation apparatus according to Supplementary Note 2, wherein

the log information generating unit specifies a command sequence corresponding to the selected event using templates in which, for each of the events, a command sequence for generating corresponding logs is registered, and generates the log information using the specified command sequence as the text data.

### Supplementary Note 5

A log generation method including:

a log classifying step of classifying log data formed of a plurality of logs into groups based on log types;
a statistical model generating step of performing, for each of the groups, a conversion of the logs classified into the group into events that are each formed of two or more logs, and further generating a statistical model by calculating, for each of the events obtained by the conversion, an appearance probability of the event based on the times of occurrence of the event and the number of instances of the event; and
a log information generating step of selecting a specific event in accordance with the appearance probabilities of the events in the statistical model and generating new logs, or log information for generating the new logs, using text data that corresponds to the selected event and that has been prepared beforehand.

### Supplementary Note 6

The log generation method according to Supplementary Note 5, wherein

in the statistical model generating step, for each of the groups, the logs classified into the group are converted into events that are each formed of two or more logs using templates in which, for each of the events, log text included in corresponding logs are registered.

### Supplementary Note 7

The log generation method according to Supplementary Note 6, wherein

in the log information generating step, matching between the selected event and the templates is performed, log text corresponding to the selected event is acquired, and the new logs are generated using the acquired log text as the text data.

### Supplementary Note 8

The log generation method according to Supplementary Note 6, wherein

in the log information generating step, a command sequence corresponding to the selected event is specified using templates in which, for each of the events, a command sequence for generating corresponding logs is registered, and the log information is generated using the specified command sequence as the text data.

### Supplementary Note 9

A computer readable recording medium that includes a program recorded thereon, the program including instructions that cause a computer to carry out:
a log classifying step of classifying log data formed of a plurality of logs into groups based on log types;
a statistical model generating step of performing, for each of the groups, a conversion of the logs classified into the group into events that are each formed of two or more logs, and further generating a statistical model by calculating, for each of the events obtained by the conversion, an appearance probability of the event based on the times of occurrence of the event and the number of instances of the event; and
a log information generating step of selecting a specific event in accordance with the appearance probabilities of the events in the statistical model and generating new logs, or log information for generating the new logs, using text data that corresponds to the selected event and that has been prepared beforehand.

### Supplementary Note 10

The computer readable recording medium according to Supplementary Note 9, wherein

in the statistical model generating step, for each of the groups, the logs classified into the group are converted into events that are each formed of two or more logs using templates in which, for each of the events, log text included in corresponding logs are registered.

### Supplementary Note 11

The computer readable recording medium according to Supplementary Note 10, wherein

in the log information generating step, matching between the selected event and the templates is performed, log text corresponding to the selected event is acquired, and the new logs are generated using the acquired log text as the text data.

### Supplementary Note 12

The computer readable recording medium according to Supplementary Note 10, wherein

in the log information generating step, a command sequence corresponding to the selected event is specified using templates in which, for each of the events, a command sequence for generating corresponding logs is registered, and the log information is generated using the specified command sequence as the text data.

Although the invention of the present application has been described above with reference to the example embodiment, the invention of the present application is not limited to the above-described example embodiment. Various changes that can be understood by a person skilled in the art within the scope of the invention of the present application can be made to the configuration and the details of the invention of the present application.

### INDUSTRIAL APPLICABILITY

As described above, according to the invention, it is possible to generate normal logs necessary in cybersecurity training without the output of logs from a terminal operating under a set environment and without human work. The present invention is useful for a cybersecurity training system.

### REFERENCE SIGNS LIST

10 Log generation apparatus (first example embodiment)
11 Log classifying unit
12 Statistical model generating unit
13 Log information generating unit
14 Log data acquiring unit
15 Parameter acquiring unit
16 Classification rule storing unit
17 Model generation rule storing unit
18 Log information storing unit
20 Log generation apparatus (second example embodiment)
21 Actual operation rule storing unit
22 Log information communicating unit
110 Computer
111 CPU
112 Main memory
113 Storage device
114 Input interface
115 Display controller
116 Data reader/writer
117 Communication interface
118 Input apparatus
119 Display apparatus
120 Recording medium
121 Bus

What is claimed is:

1. A log generation apparatus comprising:
at least one memory storing instructions; and
at least one processor configured to execute the instructions to:
classify log data formed of a plurality of logs into groups based on log types;
perform, for each of the groups, a conversion of the logs classified into the group into events that are each formed of two or more logs, and further generate a statistical model by calculating, for each of the events obtained by the conversion, an appearance probability of the event based on the times of occurrence of the event and the number of instances of the event; and
select a specific event in accordance with the appearance probabilities of the events in the statistical model and generate new logs, or log information for generating the new logs, using text data that corresponds to the selected event and that has been prepared beforehand.

2. The log generation apparatus according to claim 1, wherein, further at least one processor configured to execute the instructions to:
for each of the groups, convert the logs classified into the group into events that are each formed of two or more logs using templates in which, for each of the events, log text included in corresponding logs is registered.

3. The log generation apparatus according to claim 2, wherein, further at least one processor configured to execute the instructions to:
perform matching between the selected event and the templates, acquire log text corresponding to the selected event, and generate the new logs using the acquired log text as the text data.

4. The log generation apparatus according to claim 2, wherein, further at least one processor configured to execute the instructions to:
specify a command sequence corresponding to the selected event using templates in which, for each of the events, a command sequence for generating corresponding logs is registered, and generate the log information using the specified command sequence as the text data.

5. A log generation method comprising:
classifying log data formed of a plurality of logs into groups based on log types;
performing, for each of the groups, a conversion of the logs classified into the group into events that are each formed of two or more logs, and further generating a statistical model by calculating, for each of the events obtained by the conversion, an appearance probability of the event based on the times of occurrence of the event and the number of instances of the event; and
selecting a specific event in accordance with the appearance probabilities of the events in the statistical model and generating new logs, or log information for generating the new logs, using text data that corresponds to the selected event and that has been prepared beforehand.

6. The log generation method according to claim 5, wherein
in the generation of the statistical model, for each of the groups, the logs classified into the group are converted into events that are each formed of two or more logs using templates in which, for each of the events, log text included in corresponding logs are registered.

7. The log generation method according to claim 6, wherein
in the generation of the log information, matching between the selected event and the templates is performed, log text corresponding to the selected event is acquired, and the new logs are generated using the acquired log text as the text data.

8. The log generation method according to claim 6, wherein
in the generation of the log information, a command sequence corresponding to the selected event is specified using templates in which, for each of the events, a command sequence for generating corresponding logs is registered, and the log information is generated using the specified command sequence as the text data.

9. A non-transitory computer readable recording medium that includes a program recorded thereon, the program including instructions that cause a computer to:
classify log data formed of a plurality of logs into groups based on log types;
perform, for each of the groups, a conversion of the logs classified into the group into events that are each formed of two or more logs, and further generate a statistical model by calculating, for each of the events obtained by the conversion, an appearance probability of the event based on the times of occurrence of the event and the number of instances of the event; and
select a specific event in accordance with the appearance probabilities of the events in the statistical model and generate new logs, or log information for generating the new logs, using text data that corresponds to the selected event and that has been prepared beforehand.

10. The non-transitory computer readable recording medium according to claim 9, wherein
in the generation of the statistical model, for each of the groups, the logs classified into the group are converted into events that are each formed of two or more logs using templates in which, for each of the events, log text included in corresponding logs are registered.

11. The non-transitory computer readable recording medium according to claim 10, wherein
in the generation of the log information, matching between the selected event and the templates is performed, log text corresponding to the selected event is acquired, and the new logs are generated using the acquired log text as the text data.

12. The non-transitory computer readable recording medium according to claim 10, wherein
in the generation of the log information, a command sequence corresponding to the selected event is specified using templates in which, for each of the events, a command sequence for generating corresponding logs is registered, and the log information is generated using the specified command sequence as the text data.
